(19) United States
(12) Patent Application Publication
(10) Pub. No.: US 2022/0351262 A1
(43) Pub. Date: Nov. 3, 2022

(54) Apparatus and method for providing a social networking marketplace for peer-to-peer services

(71) Applicant: Jawad Maher Naber, Amman (JO)

(72) Inventor: Jawad Maher Naber, Amman (JO)

(21) Appl. No.: 17/309,039

(22) PCT Filed: Oct. 15, 2019
(86) PCT No.: PCT/JO2019/050013

§ 371 Date: Apr. 16, 2021

(30) Foreign Application Priority Data
Oct. 21, 2018 (JO) P/JO/2018/000096

(51) Int. Cl. G06Q 30/06; G06Q 50/10; G06Q 50/00; G06Q 10/02

(52) U.S. Cl. CPC G06Q 30/0601; G06Q 50/10; G06Q 50/01; G06Q 10/02

(57) ABSTRACT

An apparatus and method for providing a social networking marketplace for peer-to-peer services is provided. Wherein one or more processors determine the current location of a computing device. Presenting, on the display of the computing device, multiple selection options that facilitate providing peer-to-peer services. Wherein a user is enabled to browse and select a service listing linked to a service seller profile that provides a particular service, as well as schedule a service appointment, and request a peer-to-peer service. Service sellers are enabled to publicize their services via a social media module, by enabling users to create or share media content (e.g., images, videos, GIFs, etc.) linked to service listings provided by service sellers, browse media content linked to services provided by service sellers, participate in social networking, and request peer-to-peer services.

### TECHNICAL FIELD

Embodiments described herein pertain generally to the fields of social networking and online marketplaces, and more particularly, but not by way of limitation, a social networking marketplace for peer-to-peer services.

### BACKGROUND ART

Over the past two decades, most online marketplaces have typically focused on services provided in the form of goods (e.g., physical products), such as Amazon® or Alibaba®, or on services provided online in the form of electronic output (e.g., online video courses or delivering custom-designed logos in an electronic format (e.g., JPEG)), such as Fiverr® or Freelancer®. Whereas online marketplaces for peer-to-peer services focus on services provided in the form of two individuals interacting directly with each other, without intermediation by a third-party.

Current online marketplaces for peer-to-peer services primarily focus on working with businesses or enterprises rather than individuals. Wherein businesses are enabled to provide their services to potential service buyers using their platform. Example resources such as HomeAdvisor®, Zaarly®, as well as Amazon® Home & Business Services prefer to work with verified businesses as a safe option to try to guarantee professionalism when dealing with customers.

Resources such as Troolr®, Bloomchase® and Local Services by Google® are ad-based search engines that follow similar models of prioritizing businesses as service providers, however, they merely enable businesses to promote themselves online, and offer no online payment approaches for users to pay directly for peer-to-peer services. On the other hand, resources such as Upwork® and ProReferral® solely focus on businesses or enterprises as their primary customers, wherein regular individuals are unable to use their services. Furthermore, most of these resources mentioned above have focused mainly, if not solely, on maintenance or home services. Wherein they mostly pass on a broader spectrum of peer-to-peer services such as skill sharing, mentoring, tutoring, etc.

Additionally, resources such as Thumbtack® and HomeAdvisor® typically strict service sellers to purchasing credits in order to spend them on reaching potential buyers through a process of matching various potential buyers' requests with various service sellers' quotes. This imposes unnecessary limitations on service sellers (e.g., constantly purchasing and spending credits to reach service buyers) and sets discomfort for potential buyers (e.g., receiving numerous quotes from numerous service sellers). These complex approaches of quoting and matching impose a narrow space for simplicity and transparency, and limits many service sellers from communicating their services to potential buyers in a direct, cost-effective, straightforward manner.

Although all of these resources offer businesses the opportunity to list their services on their platform, yet unfortunately, they have predominantly overlooked the underlying stream of opportunities that would flow from enabling average users, professionals or freelancers to promote themselves as an autonomous service seller or provider.

Furthermore, most people and businesses promote their services nowadays using online tools such as social media platforms (e.g., Facebook®, Instagram®, Twitter®), yet they are unable to directly receive bookings or payments for peer-to-peer services from potential buyers under the same platform. Users are also unable to compare between different service sellers that offer similar peer-to-peer services on these social media platforms in the way that those resources mentioned above can using their search engine. Therefore, a hybrid approach is missing, wherein average users, professionals or freelancers have an equal opportunity to compete with businesses on a broader spectrum of peer-to-peer services. In addition to communicating and interacting directly with potential buyers, as well as receiving online payments in exchange of their services, and promoting their services on an integrated social media feed under a single platform, in a direct, efficient manner.

### SUMMARY OF INVENTION

An apparatus and method for providing a social networking marketplace for peer-to-peer services is provided. Wherein one or more processors determine the current location of a computing device. Presenting, on the display of the computing device, multiple selection options for providing peer-to-peer services, and in response to a user selecting one of the displayed multiple selection options, presenting the selected option user interface on the display of the computing device. The online marketplace includes, a search module to facilitate searching for available services from an available services database for a specific region, a presentation module to enable presentation of user interfaces configured to facilitate requesting peer-to-peer services, and a reservation module to facilitate arranging reservations between potential service buyers and service sellers. Wherein the reservation module includes a scheduling module to allow potential service buyers to reserve available appointment times of service sellers, and a transaction module to facilitate transactions between potential service buyers and service sellers. Wherein the transaction module further includes an escrow module to hold money for services reserved using online payment methods in escrow until a specific period of time after the completion of the reserved appointment. The online marketplace further includes a communication module to facilitate communications between potential service buyers and service sellers. Moreover, the online marketplace further includes a social media module to enable users to create or share media content (e.g., images, videos, GIFs, etc.) linked to service listings provided by service sellers, browse media content linked to services provided by service sellers, participate in social networking, and request peer-to-peer services.

### BRIEF DESCRIPTION OF THE DRAWINGS

The appended drawings merely illustrate example embodiments of the presented disclosure and should not be considered as limiting its scope.

FIG. 1 is a block diagram illustrating a networked system, according to some example embodiments.

FIG. 2 is a block diagram illustrating an example embodiment of a social networking marketplace for peer-to-peer services system, according to some example embodiments.

FIG. 3 is a flow diagram illustrating an example method for requesting peer-to-peer services on a computing device, according to an embodiment.

FIG. 4 is a flow diagram illustrating an example method for a potential service buyer to use the social networking marketplace for peer-to-peer services, according to some example embodiments.

FIG. 5 is a flow diagram illustrating an example method for reserving a service appointment on the social networking marketplace for peer-to-peer services, according to some example embodiments.

FIG. 6 is a flow diagram illustrating an example method for media content sharing on the social networking marketplace for peer-to-peer services, according to some example embodiments.

FIGS. 7A-7O illustrate examples of user interfaces that are displayed to a user to enable the user to request a peer-to-peer service, according to some example embodiments.

FIGS. 8A-8C illustrate examples of user interfaces that enable users to browse media content linked to service listings and request peer-to-peer services therein, according to some example embodiments.

FIG. 9 is a block diagram that illustrates a mobile computing device upon which embodiments described herein may be implemented.

### DESCRIPTION OF EMBODIMENTS

The description that follows includes systems, methods, techniques, instruction sequences, and computing machine program products that embody illustrative embodiments of the disclosure. In the following description, for the purposes of explanation, numerous specific details are set forth in order to provide an understanding of the various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Embodiments described herein provide an interactive setting for enabling a user to request a peer-to-peer service using a computing device. In particular, some embodiments herein enable mobile computing devices, such as smart phones and geo-aware cellular telephony devices, to be used in connection with a peer-to-peer service that enables users to request a service, such as requesting a piano tutor or a baby sitter, using a simplified user interface representation. Functionality, such as communicating the location of a user, the available service options, the available service sellers, and other information, can be organized and provided to the user in an efficient and user-friendly manner.

In one embodiment, a computing device can operate an application for requesting peer-to-peer services. The application can provide user interface features that provide a user of the application with information for enabling the user to request a particular type of service. For example, the user can be provided a mechanism for selecting services and service types, as well as displaying information that may affect the decision of the user in making such selections.

According to some embodiments, the information and service options made available to the user can be region-specific. For example, different peer-to-peer services and information about different services can be provided to the user based on the region that the user is located in. Thus, the service options made available to the user, as well as the information provided to the user regarding the service options can be made region-specific.

In some embodiments, different user interface features can be provided, at least in part, by an application or program that is stored and operated on a user's computing device. The application can be configured to communicate with a peer-to-peer service system that arranges services between service sellers and potential service buyers. For example, a user can request a disc jockey (DJ) to provide a service at his or her specific location, and the online marketplace system can determine available DJs that satisfy the user's request and present available DJs who are available to provide the service. Wherein the user is enabled, via user interface features, to make different selections for viewing specified information and for requesting different peer-to-peer service options based on the user selections.

According to an embodiment, the current location of a computing device can be determined so that user interface features for requesting a peer-to-peer service can be presented, on the display of the computing device, based on its real-time location.

As described herein, a “buyer”, “service buyer”, or a “potential service buyer” refer to individuals or entities that request or order a peer-to-peer service. Also, as described herein, a “seller”, or a “service seller” refer to individuals or entities (e.g., commercial businesses) that provide peer-to-peer services. As an example, a user can request a peer-to-peer service (e.g., house cleaning, baby-sitting, violin tutoring, etc.) using the system to arrange to perform the service. In addition, as described herein, “computing device” refer to computing devices that can correspond to a remote device, work station, computer, general purpose computer, Internet appliance, hand-held device, wireless device, portable device, wearable device (e.g., smart watch), smart home device (e.g., smart appliance), cellular or mobile phone, Personal Digital Assistant (PDA), smartphone, tablet, ultrabook, netbook, laptop, desktop computers (e.g., Personal Computer), multi-processor system, microprocessor-based or programmable consumer electronic, game consoles, set-top box, network personal computer (PC), mini-computer, etc. that can provide network connectivity and processing resources for enabling a user to communicate with a system over a network.

One or more embodiments described herein provide that methods, techniques, and actions performed by a computing device are performed programmatically, or as a computer-implemented method. Programmatically, as used herein, means through the use of computer-executable instructions or code. These instructions can be stored in one or more memory resources of a computing device. A programmatically performed step may or may not be automatic.

One or more embodiments described herein can be implemented using components, engines, or programmatic modules. A component, engine, or programmatic module can include a program, a subroutine, a portion of a program, a software component or a hardware component capable of performing one or more stated tasks or functions. As used herein, a module or component can exist on a hardware component. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, PDAs, laptop computers, printers, digital picture frames, network equipments (e.g., routers), tablet devices, and so forth. Memory, processing, and network resources may all be used in connection with the creation, use or performance of any method, or with the implementation of any system.

Furthermore, one or more embodiments described herein may be implemented through the use of instructions that are executable by one or more processors. These instructions may be carried on a computer-readable medium. Machines shown or described within the figures below provide examples of processing resources and computer-readable mediums on which instructions for implementing embodiments of the invention can be carried and/or executed. In particular, the various machines shown with embodiments of the invention include processor(s) and various forms of memory for holding data and instructions. Examples of computer-readable mediums include permanent memory storage devices, such as hard drives on PCs or servers. Other examples of computer storage mediums may include portable storage units, such as CD or DVD units, flash memory (such as carried-on smartphones, multifunctional devices, or tablets), and magnetic memory, and so on. Computers, terminals, network enabled devices (e.g., mobile devices, such as cell phones) are all examples of devices and machines that utilize processors, memory, and instructions stored on computer-readable mediums. Additionally, embodiments may be implemented in the form of computer programs, or a computer usable carrier medium capable of carrying such a program.

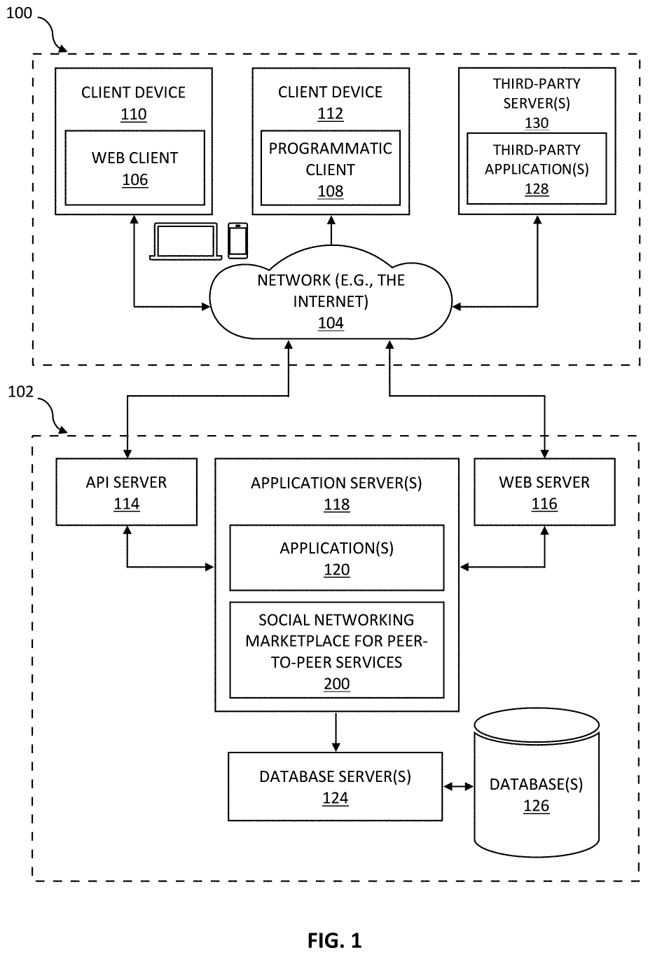

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client devices 110 and 112.

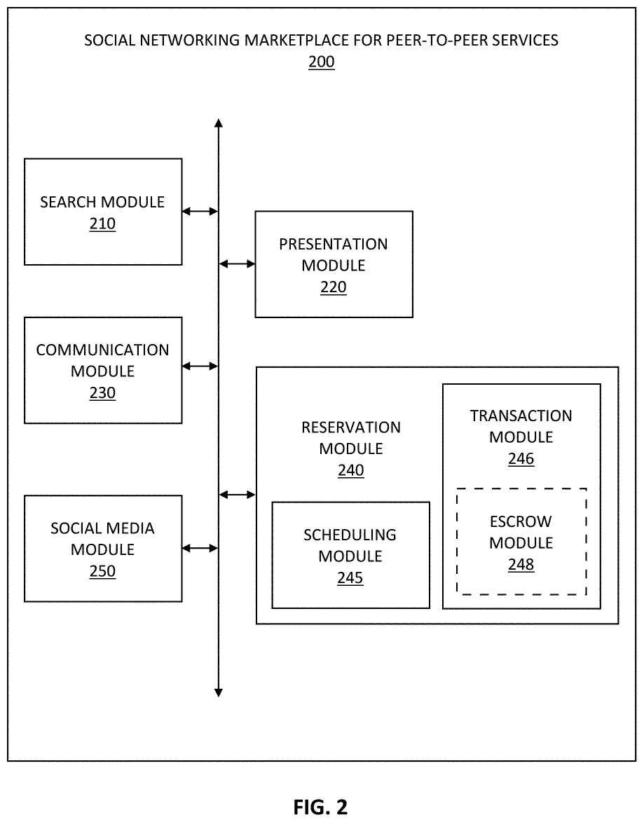

In various implementations, the client devices 110 and 112 comprise a computing device that includes at least a display and communication capabilities that provide access to the networked system 102 via the network 104. The client devices 110 and 112 comprise, but are not limited to, a remote device, work station, computer, general purpose computer, Internet appliance, hand-held device, wireless device, portable device, wearable device (e.g., smart watch), cellular or mobile phone, PDA, smartphone, tablet, ultrabook, netbook, laptop, desktop computers (e.g., PC), multi-processor system, microprocessor-based or programmable consumer electronic, game consoles, set-top box, network PC, mini-computer, and so forth. In an example embodiment, the client devices 110 and 112 comprise one or more of a touch screen, accelerometer, gyroscope, biometric sensor, camera, microphone, Global Positioning System (GPS) device, and the like. An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. According to various example embodiments, the applications 120 may be implemented on or executed by one or more of the modules of the social networking marketplace for peer-to-peer services system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102. With some example embodiments, the application servers 118 host what is referred to herein as a “social networking marketplace for peer-to-peer services” 200 or an “online marketplace” 200. The online marketplace 200 is described in more detail below in conjunction with FIG. 2.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities. In an example embodiment, the application servers 118 host a social media service that facilitates social networking, media sharing, and communication between members of the social networking marketplace for peer-to-peer services. In some embodiments, the social networking marketplace for peer-to-peer services system 200 is a part of the social media service while in other embodiments, the social networking marketplace for peer-to-peer services 200 is separate from the social media service but is communicatively coupled to the social media service.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates at least one or more third-party applications 128, executing on at least one or more third-party servers 130, as having programmatic access to the networked system 102 via the programmatic interface provided by the API server 114. For example, the third-party application(s) 128 may, utilizing information retrieved from the networked system 102, support one or more features or functions on a website hosted by the third-party. The third-party website may, for example, provide one or more functions that are supported by the relevant applications of the networked system 102.

FIG. 2 is a block diagram of the social networking marketplace for peer-to-peer services system 200 that provides functionality to facilitate providing peer-to-peer services and publicizing peer-to-peer services with media sharing between users of the online marketplace 200, according to some example embodiments. In an example embodiment, the online marketplace system 200 includes a search module 210, a presentation module 220, a communication module 230, a reservation module 240, and a social media module 250. All, or some, of the modules 210-250 of FIG. 2, communicate with each other, for example, via a network coupling, shared memory, and the like. It will be appreciated that each module can be implemented as a single module, combined into other modules, or further subdivided into multiple modules. Although not illustrated, other modules not pertinent to example embodiments can also be included.

The search module 210 provides functionality to facilitate searching for available services from an available services database for a specific region. The search module 210 provides a search query, the search query includes a plurality of parameters, the plurality of parameters includes at least, the service wanted and the time when the service wanted is desired.

The search module analyzes the search query to identify any parameters input by a user of the social networking marketplace for peer-to-peer services. The search module searches an available services database based on the parameters of the search query, wherein the available services database is populated with service listings provided by a plurality of service sellers, wherein each service listing is linked to a service seller profile providing peer-to-peer services. The user does not necessarily have to insert any input in the search query parameters, and may leave the parameters as default.

If the user selects search with or without inserting any input in the parameters, the search module 210 will present, using the presentation module 220 discussed below, any available services from the available services database for a specified region, based on any parameters input in the search query.

In some implementations, the presentation module 220 provides various presentation and user interface functionality operable to interactively present (or cause presentation) and receive information from the user. For instance, the presentation module 220 can cause presentation of user interfaces configured to facilitate requesting peer-to-peer services (e.g., display listings, social media content feed, user profiles, etc.).

In various implementations, the presentation module 220 presents or causes presentation of information (e.g., visually displaying information on a screen, acoustic output, haptic feedback). Interactively presenting information is intended to include the exchange of information between a particular device and the user. The user may provide input to interact with the user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors). It will be appreciated that the presentation module 220 provides many other user interfaces to facilitate functionality described herein. Further, it will be appreciated that “presenting” as used herein is intended to include communicating information or instructions to a particular device that is operable to perform presentation based on the communicated information or instructions.

The communication module 230 provides various communications functionality and web services. For example, the communication module 230 provides network communication such as communicating with the networked system 102, the client devices 110 and 112, and the third-party server(s) 130. In various example embodiments, the network communication can operate over wired or wireless modalities. Web services are intended to include retrieving information from the third-party server(s) 130, the database(s) 126, and the application server(s) 118. In some implementations, information retrieved by the communication module 230 comprises data linked to the user (e.g., user profile information from an online account, social network service data linked to the user), or other data to facilitate the functionality described herein. In further example embodiments, the communication module 230 provides functionality to generate alerts and notifications to facilitate communications between potential service buyers and service sellers. For example, the notifications may include email, private messages, notification registration services, text messages (Short Messaging Service (SMS), Multimedia Messaging Service (MMS), Enhanced Messaging Service (EMS), etc.) and so forth.

The reservation module 240 provides functionality to facilitate reservations between potential service buyers and service sellers. The reservation module 240 includes a scheduling module 245 to allow service sellers to specify when they are available to provide their services (e.g., date and time) and allows potential service buyers to reserve available appointment times of service sellers. The scheduling module 245 may include an interactive calendaring system such that potential service buyers may reserve available appointment times specified by service sellers to provide their services. For example, the calendaring system may graphically illustrate the availability of a service seller in providing the selected service. The calendaring system allows a potential service buyer to view the availability of a service seller, book a time and make a reservation request for one of the available times of the selected service seller. The scheduling module 245 may allow a service seller to indicate where the service will be provided (e.g., the service buyer travels to the seller, the seller travels to the buyer, neither (e.g., service is provided over the phone, Internet, etc.)). Therefore, the scheduling module 245 can allow a potential service buyer to choose where the service will be provided based on the options indicated by the service seller.

The reservation module 240 further includes a transaction module 246 that provides functionality to facilitate transactions between potential service buyers and service sellers. Wherein the transaction module further includes an escrow module 248 to hold money for services reserved using online payment methods (e.g., credit cards, debit cards, PayPal®, etc.) in escrow until a specific period of time after the completion of the reserved appointment. Service sellers are allowed to indicate whether they accept a cash payment method, an online payment method, or both. Potential service buyers are allowed to choose a method of payment, based on the accepted methods of payment indicated by a service seller.

The social media module 250 provides functionality to enable users to create or share media content linked to service listings provided by service sellers, browse media content linked to services provided by service sellers, participate in social networking, and request peer-to-peer services therein.

The social media module receives media content (e.g., images, videos, GIFs, etc.) linked to a service listing provided by a service seller, assembles the media content, and presents the media content on a graphical user interface (GUI) of a computing device, using the presentation module 220, to users of the social networking marketplace for peer-to-peer services. The social media module may allow users to use various functions such as following, liking, commenting, tagging, sharing, and so forth.

Service sellers publicize their services on the social media module by uploading media content onto the social networking marketplace for peer-to-peer services, and associating (e.g., linking) the media content with service listings that they provide. Other users (including service buyers, potential service buyers and other service sellers) of the social networking marketplace for peer-to-peer services are allowed to upload media content linked to a service listing provided by a service seller. However, service sellers must first submit a confirmation for the media content uploaded by other users and linked to the service listings they provide, in order to display it onto the social networking marketplace for peer-to-peer services. Users may be allowed to access a service listing linked to a service seller from the media content displayed on the social media module, view the service indicated in the media content and request a peer-to-peer service using the reservation module 240.

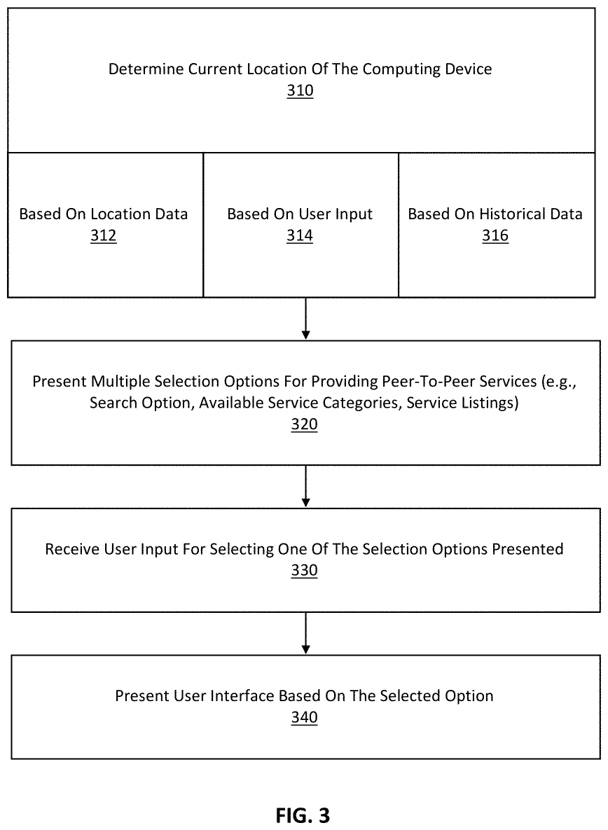

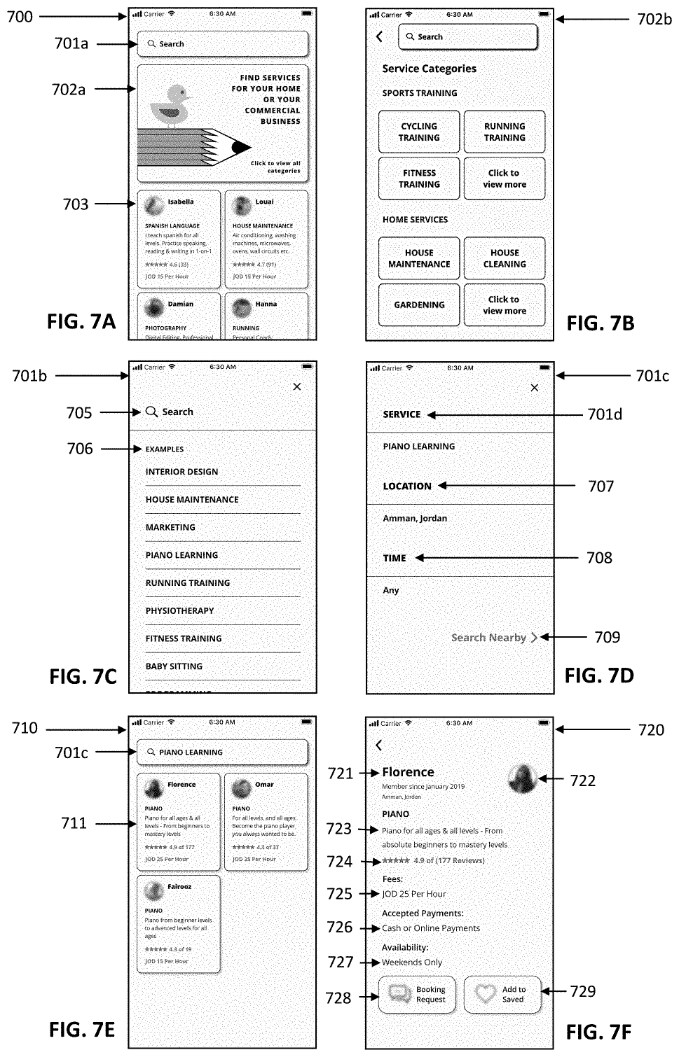

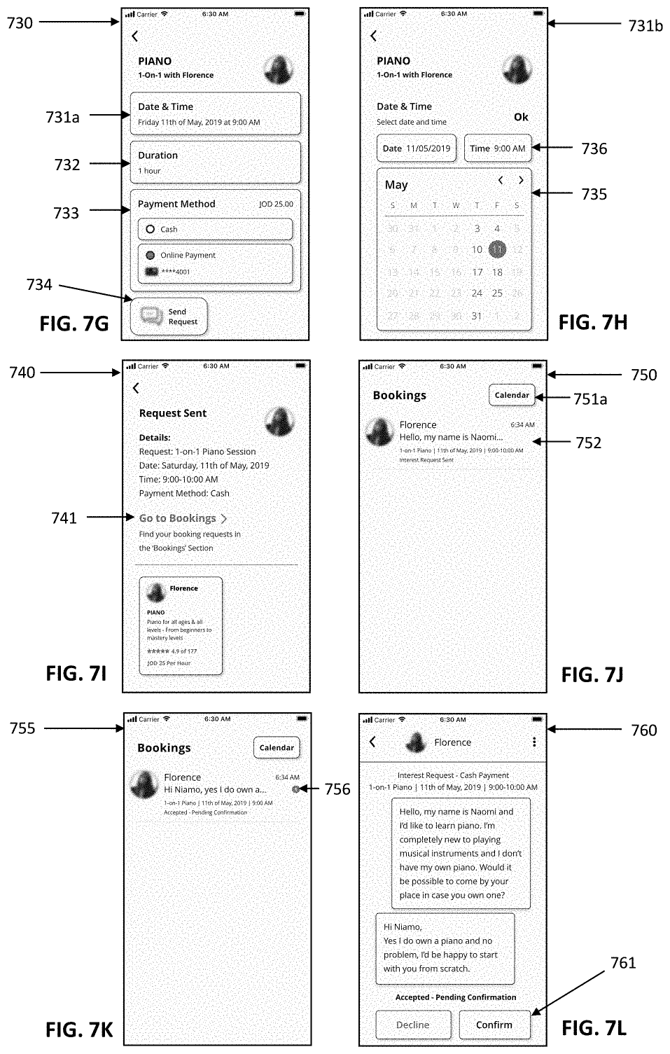

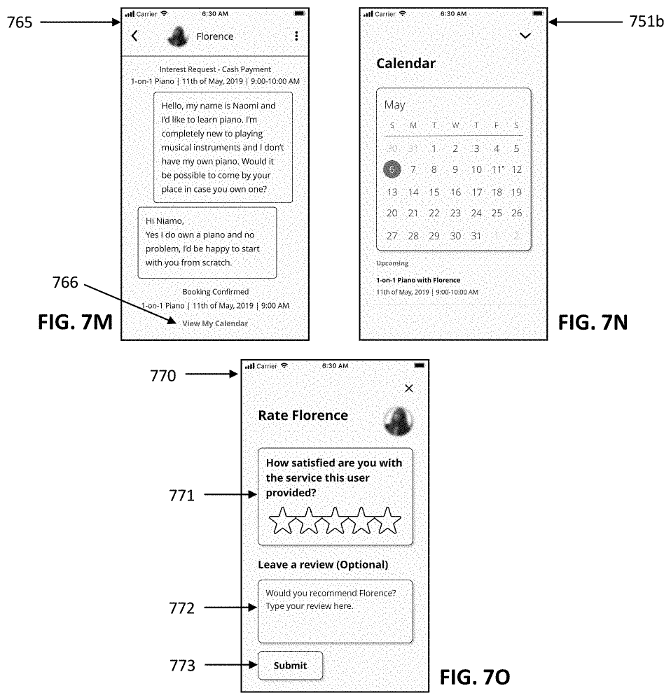

FIG. 3 illustrates an example method for requesting peer-to-peer services on a computing device, according to an embodiment. A method such as described by an embodiment of FIG. 2 can be implemented using, for example, components described within an embodiment of FIG. 7. Accordingly, references made to elements of FIG. 1 are for purposes of illustrating a suitable element or component for performing a step or sub-step being described.

The social networking marketplace for peer-to-peer services 200 can automatically determine the current location of the computing device (step 310). According to different implementations, the current location of the computing device (or the selected service location for requesting peer-to-peer services) can be determined based on location data provided by a geo-aware resource, such as a GPS component of the computing device (sub-step 312), based on user input to search and/or selection for particular locations (sub-step 314), and/or based on historical data of previous peer-to-peer service searches or previous service requests (sub-step 316). Using the current location or the service location of a user, the region or area (that includes the current location or the service location) in which requesting peer-to-peer services are to be performed can be determined by the social networking marketplace for peer-to-peer services system. In this manner, the social networking marketplace for peer-to-peer services system can identify available service sellers (e.g., Spanish teachers, dog trainers, pool cleaners, etc.) in the region that can perform the peer-to-peer service.

Based on the determined region and/or the determined current location or service location, multiple selection options for selecting one or more of the plurality of available service options can be presented on the display of the computing device (step 320). The multiple selection options can include a search option that allows users to search for available services from an available services database (as discussed earlier in the search module 210), available service categories, and/or available service listings within the region of the computing device.

The user is enabled to interact with the multiple selection options presented on the GUI of the computing device in order to make a selection of one of the multiple selection options. Wherein the social networking marketplace for peer-to-peer services receives the user input for a selected option (step 330), and presents a user interface based on the selected option (step 340).

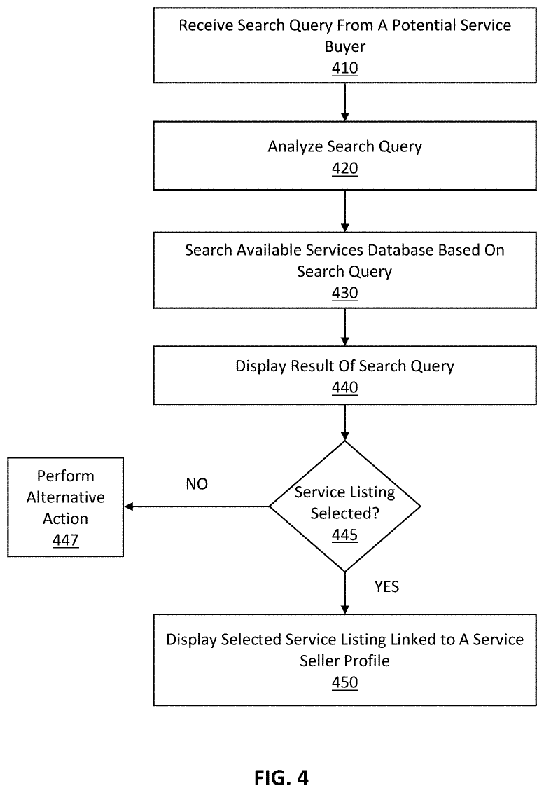

FIG. 4 is a flow diagram illustrating an example method for a potential service buyer to use the social networking marketplace for peer-to-peer services, according to some example embodiments. The operations of FIG. 4 will be described with reference to the example embodiment of FIG. 2. However, it should be understood that the operations of FIG. 4 can be performed by embodiments of the invention other than those discussed with reference to FIG. 2, and the embodiments discussed with reference to FIG. 2 can perform operations different than those discussed with reference to FIG. 4.

According to one embodiment of the invention, the social networking marketplace for peer-to-peer services 200 (illustrated in FIG. 2) performs the operations of FIG. 4. With reference to FIG. 4, at block 410, a search query is received from a potential service buyer. With reference to FIG. 2, the search module 210 receives a search query submitted from a potential service buyer. Flow moves from block 410 to 420 where the search module 210 analyzes the received search query to determine the search parameters.

At block 430, an available services database is searched based on the search parameters of the search query. With reference to FIGS. 1 and 2, the search module 210 searches the available services database 126 based on the search parameters of the received search query. Flow moves from block 430 to 440. At block 440, the presentation module 220 displays the result of the search query on the GUI of the computing device. Based on the search result displayed, a user is able to select a service listing linked to a service seller profile. If the user does not select a service listing, an alternative action is taken 447. If a user selects a service listing, the presentation module 220 displays the selected service listing linked to a service seller profile 450 on the GUI of his or her computing device.

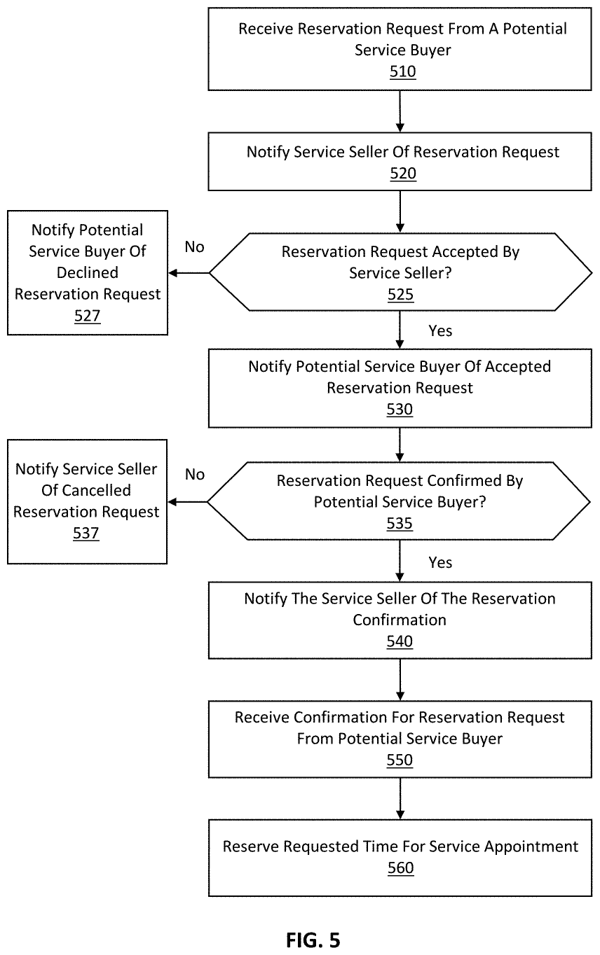

According to one embodiment of the invention, the social networking marketplace for peer-to-peer services 200 (illustrated in FIG. 2) performs the operations of FIG. 5. With reference to FIG. 5, at block 510, a reservation request for a service provided by a service seller is received from a potential service buyer. With reference to FIG. 2, the reservation module 240 receives a reservation request submitted by a potential service buyer. Flow moves from block 510 to 520. The communication module 230 notifies the service seller of the reservation request 520 and flow moves from block 520 to 525. At block 525, the service seller is enabled to accept or decline the reservation request submitted by the potential service buyer. If the service seller chooses to decline the reservation request submitted by the potential service buyer, the communication module 230 notifies the potential service buyer of the declined reservation request 527. If the service seller chooses to accept the reservation request, the communication module 230 notifies the potential service buyer of the accepted reservation request 530 and the potential service buyer is thereby enabled to submit a confirmation for the reservation request 535 and reserve the service provided by the service seller 560. If the potential service buyer chooses to cancel the reservation request, the communication module 230 notifies the service seller of the canceled reservation request 537. If the potential service buyer chooses to confirm the reservation request, the communication module 230 notifies the service seller of the reservation confirmation 540, and if the potential service buyer chose an online payment method to pay for the service, then the escrow module 248 holds the money in escrow until a specific period of time after the completion of the reserved appointment. The online marketplace 200 receives the confirmation for the reservation request 550, wherein the reservation module 240 reserves the requested time for the service appointment 560 on the online marketplace 200, and the scheduling module 245 blocks off an availability in the service listing linked to the service seller profile.

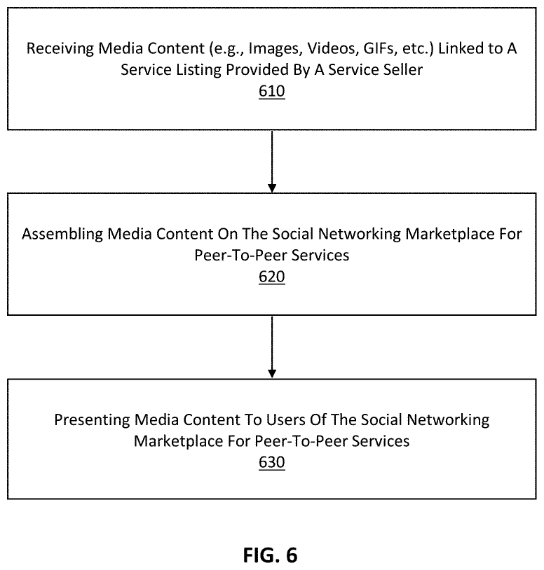

According to one embodiment of the invention, the online marketplace 200 (illustrated in FIG. 2) performs the operations of FIG. 6. With reference to FIG. 2, the social media module 250 receives media content (e.g., images videos, GIFs, etc.) linked to a service listing provided by a service seller 610. Flow moves from block 610 to 620. At block 620, the social media module 250 assembles the media content on the online marketplace 200. Flow moves from block 620 to 630. At block 630, the presentation module 220 displays, on the GUI of a computing device, the media content to users of the online marketplace 200. Wherein users may be allowed to access a service listing linked to a service seller from the media content displayed on the social media module, view the service indicated in the media content, and request a service therein using the reservation module 240.

Users of the online marketplace 200 may choose to view and request services from other regions that do not include the current location of their computing device, by selecting a different region available on the online marketplace 200. Therefore, the online marketplace 200 does not limit users to viewing and requesting services only within the region that includes the current location of their computing device.

### User Interface Examples

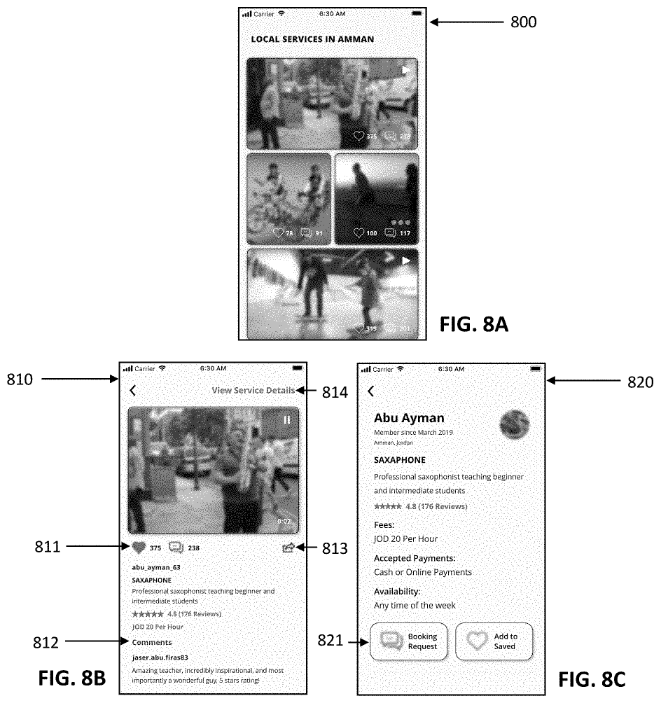

FIGS. 7A-7O illustrate examples of user interfaces that are displayed to a user to enable the user to request a peer-to-peer service, according to some example embodiments. FIG. 7A illustrates multiple selection options as described in FIG. 3. FIGS. 7B-7E illustrate the available service categories, the search option and the search query as described in FIGS. 2-4. FIGS. 7F-7O illustrates a set of example user interfaces that demonstrate an example for requesting a peer-to-peer service. FIGS. 8A-8C illustrate examples of user interfaces that enable users to browse media content linked to service listings and request peer-to-peer services therein, according to some example embodiments, as explained in FIGS. 2 and 6.

When a user initiates and operates the social networking marketplace for peer-to-peer services on his or her computing device, for example, a home page user interface 700 can be provided to the user based on the determined region, and/or the determined current location or service location, as discussed in FIG. 3. The user can interact with features on the home page user interface 700 in order to request a service. In some implementations, the home page user interface 700 can include multiple selection options, as discussed earlier in FIG. 3. The multiple selection options may include, but is not limited to, a search option 701a that allows users to search for available services from an available services database for a specific region, an available service categories option 702a, and a set of example service listings within a region that includes the current location of a computing device 703.

An available service categories user interface 702b, may enable users to view a category that includes a set of service options linked to a specific service category and select an available service option from the available service categories. For example, a ‘Sports Training’ service category can include various service options, such as cycling training, fitness training, basketball training, and so forth. Each service category includes at least one or more service options, and each service option includes a plurality of service listings linked to service seller profiles. Furthermore, available service categories and service options may vary between different regions and are therefore not limited to a specific set of options or categories within each region in which the service is being provided.

The example service listings 703 present, in the form of content cards displayed on the user interface of a computing device, a brief summary of the key information included in those service listings. Key information may include, but is not limited to, a description of the services provided by a service seller, a rating score generated from at least one or more ratings submitted by service buyers, the fees charged by a service seller in exchange of the services he or she provides, and/or the name of a service seller, and so forth.

It should be understood that FIG. 7A merely illustrates an example home page user interface on the online marketplace 200, and does not limit the invention to the user interface illustrated. Wherein the options displayed on the user interface may further include selection options not illustrated in FIG. 7A (e.g., a sort option, icons and/or buttons to move between different user interfaces throughout the online marketplace 200) or fewer selection options (e.g., the example service listings are not displayed on the home page user interface 700, wherein service listings may generally be found using the search option or by browsing the available service options from the available service categories and so on). Moreover, the multiple selection options can be arranged differently on the user interface of a computing device (e.g., the search option may appear on the bottom of the user interface instead of on the top, etc.).

The user is enabled to interact with the multiple selection options presented on the GUI 700 of a computing device in order to make a selection of one of the multiple selection options, wherein the social networking marketplace for peer-to-peer services receives the user input for a selected option, and presents a user interface based on the selected option, as discussed earlier in FIG. 3.

When the search option 701a is selected, an example user interface is displayed 701b, and a user is able to type into the search field 705 the service he or she is looking for, or select an available service option from the example set of available service options 706. In another example, if a user types into the search field a service option that is not available in the available services database, the user is prompted to input another entry into the search field 705 or select an available service option from the example set of available service options 706.

If a service option is selected, an example user interface 701c can be displayed, wherein a user is able to modify the search query according to his or her preferences. A user is able to modify the service option he or she is looking for in 701b, and/or the location option where the service will be provided 707, and/or the time option 708 regarding to when the service wanted is desired. The search query is not limited to the options indicated in FIGS. 7C to 7D and can include further options such as modifying the fees range, the acceptable methods of payment (cash or online payment), the preferred location where the service is delivered (e.g., at the potential service buyers' location or at the service sellers' location), and/or the minimum rating score, and so forth.

FIG. 7E illustrates an example user interface of a search query result for a ‘piano learning’ service option 710. A user can be prompted to either select a service listing from the service listings displayed 711, or select the search option 701c in order to modify the search query according to his or her preference.

FIG. 7F illustrates an example user interface of a selected service listing from the service listings 711 presented in the search query result user interface 710. A service listing user interface 720 includes at least a description of the services that the service seller provides 723, a set of one or more ratings that make up the rating score of the service seller 724, the fees charged by the service seller for the services he or she provides 725, the accepted methods of payment (cash or online methods of payment) 726, the availability of the service seller (specific times of the week can be indicated) 727, and an option to request the services offered by the service seller 728.

A service listing user interface can additionally include the name of the service seller (as shown in 721), a picture of the service seller 722, and/or an option to save a service listing 729 into a separate personalized user interface that includes saved service listings for a user.

The user interface 720 includes some example embodiments of a service listing user interface, and therefore is not limited to the service listing embodiments shown in FIG. 7F. A service listing user interface may further include verifications for a service seller (verifications may include personal information linked to a service seller, such as a service sellers' email address, phone number, third-party accounts linked to a service seller profile (e.g., Facebook®, Google®, LinkedIn®, etc.), an official identification verification (government ID, drivers' license, visa, national identity card, etc.), and/or verifications for official licenses to practice the services offered by service sellers (e.g., professional license)). Moreover, a service listing may further include a description of the qualifications of a service seller, highlights of the services provided by a service seller which can be presented by media content (e.g., images, videos, GIFs, etc.), a cancellation policy for online payments (e.g., a service seller receives a fixed amount or percentage of the fees charged for a service appointment if a potential service buyer chooses to cancel a service appointment after the time specified in the service sellers' cancellation policy), contact information of a service seller (e.g., phone number, email address, etc.), the location of a service seller, an indication of the languages spoken by a service seller, an indication for any consultation fees that may be indicated by a service seller, and/or an indication of a free service session being offered by a service seller to potential service buyers, and so on and so forth.

FIGS. 7G-7I illustrate example user interfaces of a reservation request for a service provided by a service seller 720, as discussed earlier in FIGS. 2, 4, and 5. A reservation request user interface 730 may include a date and time field 731a which can be used by potential service buyers to reserve available appointment times using an interactive calendaring system such that potential service buyers may reserve available appointment times of service sellers. The date and time field 731a, when selected, displays an interactive calendar 731b which includes options to select an available date 735 and time 736 for the service seller to provide the service. A reservation request 730 user interface further includes a duration field 732 that potential service buyers use to specify the amount of time for which the service will be provided (e.g., in minutes or hours), a method of payment field 733 (which indicates the amount required by a potential service buyer to pay for the service requested, and the methods of payment accepted by a service seller to allow potential service buyers to pay for his or her services), and an option to send a reservation request to the service seller 734.

Although not illustrated in FIG. 7G, a reservation request user interface 730 may further include options to facilitate requesting a service, options may include an optional message for potential service buyers to notify a service seller of any information regarding the reservation request (e.g., specific service requests, specific location information, etc.), an option to select where the service will be provided (service sellers' location, potential service buyers' location, online, etc.), and so forth.

Once a reservation request is sent, a user interface indicating a summary of the requested service details is presented 740, and an option 741 to enable the potential service buyer to find his or her reservation requests in a separate personal user interface that facilitates communication between the potential service buyer and the service seller 750.

FIGS. 7J-7L illustrate example user interfaces of a communication between a potential service buyer and a service seller. A potential service buyer may find his or her reservation request 752 in a separate personal user interface 750, select an option 751a to view a personal interactive calendar that indicates any upcoming confirmed reservations, as well as receive any notifications 756 communicated from the service seller (as shown in 755). When a reservation request 756 is selected, an example user interface 760 is displayed that illustrates an example conversation between a potential service buyer and a service seller, wherein the service seller has accepted the potential service buyers' reservation request and the potential service buyer is asked to confirm or decline the reservation request 761.

FIGS. 7M-7N illustrate example user interfaces wherein the potential service buyer confirmed the reservation request 765 and an option is displayed 766 to view the confirmed reservation in a personal interactive calendar 751b, which can additionally be accessed from the calendar option 751a. Additionally, both users can be notified about the service request confirmation details via email, text message, private message, notification registration services, etc.

FIG. 7O illustrates an example rating user interface 770 that can be displayed to the service buyer after the end of the duration of the service reservation, wherein a service buyer is given the option to rate the service seller 771, type in a review 772, and submit the rating with/without a review onto the service seller listing 773.

A rating user interface is not limited to the options described above and can include several other options such as rating a service sellers' punctuality, friendliness, effectiveness, and so forth. A rating user interface may also be displayed to service sellers in which it allows them to submit a rating as well as a review on service buyers' profiles.

Although not illustrated in FIGS. 7A-7O, the social networking marketplace for peer-to-peer services 200 also includes a profile manager that includes a registration module to allow users to register with the online marketplace 200 and the services provided by the online marketplace 200 (e.g., notification registration services). The profile manager also manages user profiles including managing users' characteristics (e.g., updating and calculating buyer and seller ratings, maintaining their media highlights, maintaining service seller listings, etc.).

FIGS. 8A-8C illustrate examples of user interfaces that enable users to browse media content linked to service listings and request peer-to-peer services therein, according to some example embodiments.

Service sellers are able to publicize their services through media content (e.g., images, videos, GIFs, etc.) linked to the service listings they provide on the social networking marketplace for peer-to-peer services. Whereas users can create or share media content linked to services provided by service sellers, as discussed earlier in FIGS. 2 and 6.

Users are able to browse media content linked to services provided by service sellers 800, view media content and participate in social networking 810 (e.g., like, comment, follow, tag, share, etc.), as well as access the linked service listings from the media content 820, and request peer-to-peer services therein.

A media content example 810, selected from multiple media content examples 800, illustrates a service provided by a service seller within a specific region. The example user interface 810 illustrates social networking features such as liking 811, commenting 812 and sharing the media content displayed 813 (e.g., SMS messages, MMS, EMS, email, or through third-party applications (e.g., WhatsApp®, Facebook®, Instagram®, etc.)). The media content example user interface 810 further includes an option 814 to enable potential service buyers to view the service listing 820 linked to the service seller and enables them to request the service presented in the service listing 821.

It should be understood that FIGS. 8A-8C merely illustrate example user interfaces on the online marketplace 200, and does not limit the invention to the user interfaces illustrated. Wherein the options displayed on the user interface of FIG. 8A for instance, may include further selection options not being illustrated in the example user interfaces (e.g., a search option, a sort option, an option to upload or create media content, icons and/or buttons to move between different user interfaces throughout the online marketplace 200, etc.).

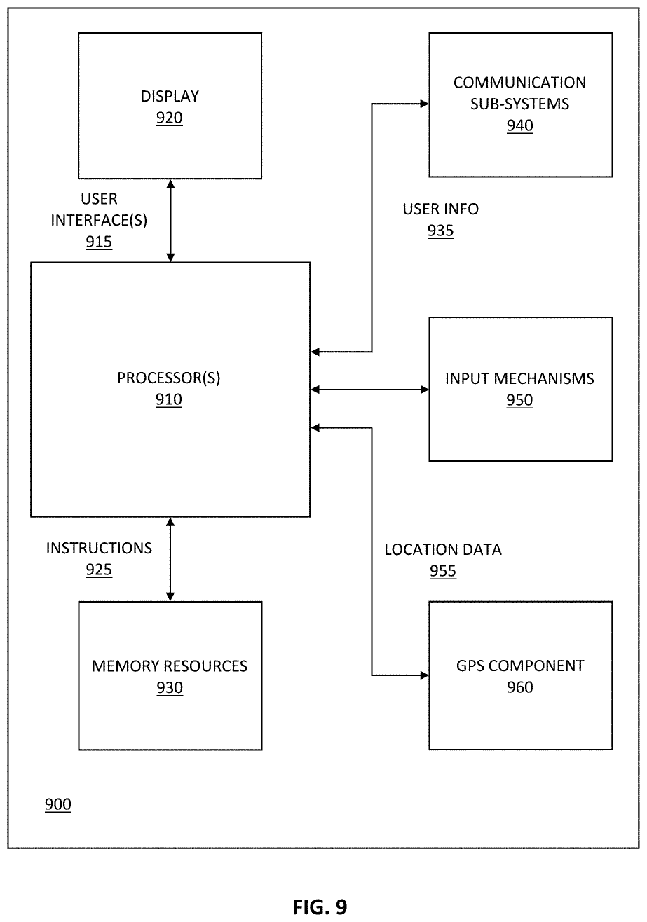

FIG. 9 is a block diagram that illustrates a mobile computing device upon which embodiments described herein may be implemented. In one embodiment, the computing device 900 may correspond to a mobile computing device, such as a cellular device that is capable of telephony, messaging, and data services. Examples of such devices include smartphones, handsets or tablet devices for cellular carriers. Computing device 900 includes a processor 910, a display device 920 (e.g., such as a touch-sensitive display device), memory resources 930, one or more communication sub-systems 940 (including wireless communication sub-systems) (e.g., BLUETOOTH®, WiFi®, Infrared®, etc.), input mechanisms 950 (e.g., an input mechanism can include or be part of a touch-sensitive display device (e.g., touchscreen, touchpad)), and one or more location detection mechanisms (e.g., GPS component) 960. In one example, at least one of the communication sub-systems 940 sends and receives cellular data over data channels and voice channels.

The processor 910 is configured with software and/or other logic to perform one or more processes, steps, and other functions described with implementations, such as described by FIGS. 1-8C, and elsewhere in the application. Processor 910 is configured, with instructions 925 and data stored in the memory resources 930, to operate an online marketplace 200 as described in FIGS. 1-8C. For example, instructions for operating the online marketplace application in order to display various user interfaces, such as described in FIGS. 7A-8C, can be stored in the memory resources 930 of the computing device 900. In one implementation, a user can operate the online marketplace application so that location data 955 can be received by the GPS component 960. The location data 955 can be used by the application to present user interface features that may be specific to the current location of the computing device 900.

The location data 955 can also be provided to the online marketplace system using the communication sub-systems 940. The communication sub-systems 940 can enable the computing device 900 to communicate with other servers and computing devices, for example, over a network (e.g., wirelessly or using a wireline). The location data 955 can be communicated to the online marketplace system so that when the user makes a reservation request, the system can arrange the service between a potential service buyer and a service seller. The communication sub-systems 940 can also receive user information 935 (such as location information of users in real-time) from the online marketplace system 200 and transmit the user information 935 to the processor 910 for displaying user data on one or more user interfaces 915.

The processor 910 can cause user interface features to be presented on the display 920 by executing instructions 925 and/or applications that are stored in the memory resources 930. In some examples, user interfaces 915, such as user interfaces described with respect to FIGS. 7A-8C, can be provided by the processor 910 based on user input and/or selections received from the user. In some implementations, the user can interact with the touch-sensitive display 920 to make selections on the different user interface features 915 so that region-specific information (that is based on the user selections in this case) can be provided with the user interface features 915. While FIG. 9 is illustrated for a mobile computing device, one or more embodiments may be implemented on, but is not limited to, other types of devices, including fully-functional computers (such as laptop computers, desktop computers (e.g., PCs)), server computers, client computers, tablet computers, netbooks, PDAs, wearable devices (e.g., smart watches), smart home devices (e.g., smart appliances), other smart devices, and so forth.

It is contemplated for embodiments described herein to extend the individual elements and concepts described herein, independently of other concepts, ideas, or systems, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in the art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

What is claimed is:

1. A computer-readable medium that configures a computing device to perform functions, using at least one or more processors, to provide a social networking marketplace for peer-to-peer services, the functions comprising:
determining a current location of the computing device;
presenting, on the display of the computing device, multiple selection options for providing peer-to-peer services; and
in response to the user selecting one of the multiple selection options, presenting the selected option user interface on the display of the computing device.

2. The computer-readable medium of claim 1, further includes a search module to facilitate searching for available services from an available services database for a specific region, the search module comprises:
receiving a search query from a potential service buyer, the search query including a plurality of parameters, the plurality of parameters includes at least, the service wanted and the time when the service wanted is desired;
analyzing the search query to identify the parameters; and
searching an available services database based on the parameters of the search query, wherein the available services database is populated with service listings provided by a plurality of service sellers, wherein each service listing is linked to a service seller profile providing peer-to-peer services, each service listing includes at least the following:
a description of the service that the service seller provides,
the service seller fees for providing peer-to-peer services,
the method of payment accepted by the service seller,
a set of one or more ratings submitted by one or more service buyers, and
an option to request the service offered by the service seller.

3. The computer-readable medium of claim 1, further includes a presentation module to enable presentation of user interfaces configured to facilitate requesting peer-to-peer services.

4. The computer-readable medium of claim 1, further includes a reservation module to facilitate arranging reservations between potential service buyers and service sellers.

5. The computer-readable medium of claim 4, wherein the reservation module includes a scheduling module to allow potential service buyers to reserve available appointment times of service sellers.

6. The computer-readable medium of claim 4, wherein the reservation module further includes a transaction module to facilitate transactions between potential service buyers and service sellers.

7. The computer-readable medium of claim 6, wherein the transaction module further includes an escrow module to hold money for services reserved using online payment methods in escrow until a specific period of time after the completion of the reserved appointment.

8. The computer-readable medium of claim 1, further includes a communication module to facilitate communications between potential service buyers and service sellers.

9. The computer-readable medium of claim 1, further comprises:
receiving a reservation request from a potential service buyer for a selected service during one of the available times of the selected service seller;
notifying the selected service seller of the service appointment;
enabling the service seller to accept or decline the service requested;
receiving a response from the service seller to provide the service requested;
notifying the potential service buyer of the service seller response to provide the service requested;
enabling the potential service buyer, upon acceptance of the service seller to provide the service requested, to confirm or cancel the service requested;
receiving a response from the potential service buyer to confirm or cancel the service requested; and
reserving, upon confirmation of the potential service buyer for the service requested, the requested time for the service seller to provide the selected service to the potential service buyer wherein a service appointment is created.

10. The computer-readable medium of claim 1, further includes a social media module to enable users to create or share media content linked to service listings provided by service sellers, browse media content linked to services provided by service sellers, participate in social networking, and request peer-to-peer services, wherein the social media module comprises:
receiving media content linked to a service listing provided by a service seller;
assembling the media content on the social networking marketplace for peer-to-peer services; and
presenting the media content to users of the social networking marketplace for peer-to-peer services.

11. A computer-implemented method performed on the computing system of a social networking marketplace for peer-to-peer services, comprising:
determining a current location of the computing device;
presenting, on the display of the computing device, multiple selection options for providing peer-to-peer services; and
in response to the user selecting one of the multiple selection options, presenting the selected option user interface on the display of the computing device.

12. The computer-implemented method of claim 11, further includes a search module to facilitate searching for available services from an available services database for a specific region, the search module comprises:
receiving a search query from a potential service buyer, the search query including a plurality of parameters, the plurality of parameters includes at least, the service wanted and the time when the service wanted is desired;
analyzing the search query to identify the parameters; and
searching an available services database based on the parameters of the search query, wherein the available services database is populated with service listings provided by a plurality of service sellers, wherein each service listing is linked to a service seller profile providing peer-to-peer services, each service listing includes at least the following:
a description of the service that the service seller provides,
the service seller fees for providing peer-to-peer services,
the method of payment accepted by the service seller,
a set of one or more ratings submitted by one or more service buyers, and
an option to request the service offered by the service seller.

13. The computer-implemented method of claim 11, further includes a presentation module to enable presentation of user interfaces configured to facilitate requesting peer-to-peer services.

14. The computer-implemented method of claim 11, further includes a reservation module to facilitate arranging reservations between potential service buyers and service sellers.

15. The computer-implemented method of claim 14, wherein the reservation module includes a scheduling module to allow potential service buyers to reserve available appointment times of service sellers.

16. The computer-implemented method of claim 14, wherein the reservation module further includes a transaction module to facilitate transactions between potential service buyers and service sellers.

17. The computer-implemented method of claim 16, wherein the transaction module further includes an escrow module to hold money for services reserved using online payment methods in escrow until a specific period of time after the completion of the reserved appointment.

18. The computer-implemented method of claim 11, further includes a communication module to facilitate communications between potential service buyers and service sellers.

19. The computer-implemented method of claim 11, further comprises:
receiving a reservation request from a potential service buyer for a selected service during one of the available times of the selected service seller;
notifying the selected service seller of the service appointment;
enabling the service seller to accept or decline the service requested;
receiving a response from the service seller to provide the service requested;
notifying the potential service buyer of the service seller response to provide the service requested;
enabling the potential service buyer, upon acceptance of the service seller to provide the service requested, to confirm or cancel the service requested;
receiving a response from the potential service buyer to confirm or cancel the service requested; and
reserving, upon confirmation of the potential service buyer for the service requested, the requested time for the service seller to provide the selected service to the potential service buyer wherein a service appointment is created.

20. The computer-implemented method of claim 11, further includes a social media module to enable users to create or share media content linked to service listings provided by service sellers, browse media content linked to services provided by service sellers, participate in social networking, and request peer-to-peer services, wherein the social media module comprises:
receiving media content linked to a service listing provided by a service seller;
assembling the media content on the social networking marketplace for peer-to-peer services; and
presenting the media content to users of the social networking marketplace for peer-to-peer services.
